(19) United States
(12) Patent Application Publication
(10) Pub. No.: US 2005/0010425 A1
(43) Pub. Date: Jan. 13, 2005

(54) Process for producing real estate documents

(76) Inventor: Paul Raymond Mazzochi, Vineland, NJ (US)

Correspondence Address: Paul Raymond Mazzochi, 58 Laurel Street, Vineland, NJ, 08360, US

(21) Appl. No.: 10/615,684

(22) Filed: Jul. 9, 2003

(51) Int. Cl. G06F 17/60

(52) U.S. Cl. 705/1

(57) ABSTRACT

A process for producing real estate documents with the steps of: a central controller including a CPU and a memory operatively connected to the CPU, a storage means for storing data on a storage medium connected to the CPU, at least one terminal, adapted for communicating with the central controller, for transmitting to the central controller information about the real estate transaction, the memory in the central controller containing a program, adapted to be executed by the CPU, for calculating the mathematical results of the information entered, the program is also adapted for generating real estate documents, the program is further adapted to transmit the real estate documents to a terminal, wherein the central controller receives real estate transaction information from the terminal and calculates the results based upon the information entered, and wherein the central controller receives real estate transaction information from the terminal, produces the real estate documents and transmits the documents to the terminal and wherein the program in memory is further adapted to perform a credit card or other payment transaction to provide the real estate document services to the customer.

### CROSS REFERENCE TO RELATED APPLICATIONS

Not Applicable

### STATEMENT REGARDING FEDERALLY-SPONSORED RESEARCH OR DEVELOPMENT

Not Applicable

### REFERENCE TO COMPUTER PROGRAM LISTING APPENDIX

This application includes a computer program listing appendix submitted on a compact disc. The computer listing is provided on a single CD-R and is accompanied by a duplicate copy (two CD-R in total). The material contained on the CD-R is hereby incorporated herein by reference and consists of one ASCII text file, titled “Appendix.txt,” created on Jul. 3, 2003, and comprising 785,775 bytes.

### BACKGROUND OF THE INVENTION

The present invention relates generally to the field of real estate and more specifically to a process for producing real estate documents.

In 1974, the Federal government passed the Real Estate Settlement Procedures Act (RESPA). RESPA is about closing costs and settlement procedures. RESPA requires that consumers receive disclosures at various times in the transaction and outlaws kickbacks that increase the cost of settlement services. This act states that specific documents must be produced for all real estate transactions. Furthermore, copies of these documents must be provided to all parties involved in the real estate transaction. These documents include, but are not limited to, the Housing and Urban Development Uniform Settlement Statement (HUD-1), Housing and Urban Development Settlement Statement Optional Form for Transactions without Sellers (HUD-1A), Federal Truth-In-Lending Disclosure Statement and Escrow Disbursement Statement. In order to complete these documents, many complex calculations must be performed. Moreover, the information contained within these documents is usually changed frequently. Thus, constant revisions and recalculations are often necessary. So, filling out these forms by hand is tedious, time-consuming work.

Since the inception of the computer, there have been many real estate software packages that will handle calculating and producing the required RESPA (real estate) documents. These programs operate as any other piece of available software. One would obtain the program software, purchase it from a vendor or dealer and install it onto a computer. Even with the proliferation of the Internet, real estate software is still downloaded, purchased, and installed onto a computer. This method of obtaining, purchasing and installing real estate software has many disadvantages. It requires one to physically obtain or purchase a software program and install that program onto a computer. This software is often expensive and may require a third party (e.g., a computer consultant) to install it. Often, the software would have to be configured to work with a specific printer or computer. Updates may routinely have to be obtained or purchased and physically installed on the computer where the software is located. If a network or multiple computers are involved, additional software licenses must usually be obtained or purchased. This method also limits access to the software in that a user must usually be physically located at the machine on which the software is installed. Therefore, a user is often unable to work from a different location such as their home or an alternate office.

This antiquated way of handling real estate software is cumbersome and usually requires a lot of time, effort and expense on the part of the user. It is unnecessary for someone to obtain, purchase, install, configure and maintain a real estate software program. What is necessary is access to a means of producing the completed real estate (RESPA) documents.

### BRIEF SUMMARY OF THE INVENTION

The primary object of the invention is to provide a method, apparatus, and process for producing real estate (RESPA) documents, including but not limited to the HUD-1, HUD-1A, Federal Truth-In-Lending Disclosure Statement, and Escrow Disbursement documents.

Another object of the invention is to provide a means for performing the mathematical operations necessary to complete said documents.

Another object of the invention is to provide a means for editing and recalculating said documents.

A further object of the invention is to provide a means for generating completed copies of said documents.

Yet another object of the invention is to provide a means of delivering said documents to a user upon the user's request.

Still yet another object of the invention is to provide access to and use of the invention from any location via the Internet.

Other objects and advantages of the present invention will become apparent from the following descriptions, taken in connection with the accompanying drawings, wherein, by way of illustration and example, an embodiment of the present invention is disclosed.

In accordance with a preferred embodiment of the invention, there is disclosed a process for producing real estate documents comprising the steps of: a central controller including a CPU and a memory operatively connected to the CPU, a storage means for storing data on a storage medium connected to the CPU, at least one terminal, adapted for communicating with the central controller, for transmitting to the central controller information about the real estate transaction, the memory in the central controller containing a program, adapted to be executed by said CPU, for calculating the mathematical results of the information received, wherein said central controller receives real estate transaction information from said terminal and calculates the results based upon the information received, and wherein said central controller receives real estate transaction information from said terminal, produces the real estate (RESPA) documents and transmits the documents to said terminal, and wherein the program in memory is further adapted to perform a credit card or other payment transaction to provide the real estate document services to the customer.

### BRIEF DESCRIPTION OF THE DRAWINGS

The drawings constitute a part of this specification and include exemplary embodiments to the invention, which may be embodied in various forms. It is to be understood that in some instances various aspects of the invention may be shown exaggerated, enlarged or reduced to facilitate an understanding of the invention.

FIG. 1 is a block diagram depicting one embodiment of the present invention.

FIG. 2 is a flow chart depicting the flow of the method of the present invention FIG. 3 is a representation of a computer screen in the illustrated embodiment of the invention representing an interface with the user to provide a table of contents.

FIG. 4 is a representation of a computer screen in the illustrated embodiment of the invention representing an interface with the user in any number of real estate information entry sections.

FIG. 5 is a representation of a computer screen in the illustrated embodiment of the invention representing an interface with the user to provide default settings.

FIG. 6 is a representation of the information contained on page one of the HUD-1 document.

FIG. 7 is a representation of the information contained on page two of the HUD-1document.

FIG. 8 is a representation of the information contained on the HUD-1A document.

FIG. 9 is a representation of the information contained on the Federal Truth-In-Lending Disclosure Statement.

FIG. 10 is a representation of the Escrow Disbursement Statement.

### DETAILED DESCRIPTION OF THE PREFERRED EMBODIMENTS

Detailed descriptions of the preferred embodiment are provided herein. It is to be understood, however, that the present invention may be embodied in various forms. Therefore, specific details disclosed herein are not to be interpreted as limiting, but rather as a basis for the claims and as a representative basis for teaching one skilled in the art to employ the present invention in virtually any appropriately detailed system, structure or manner.

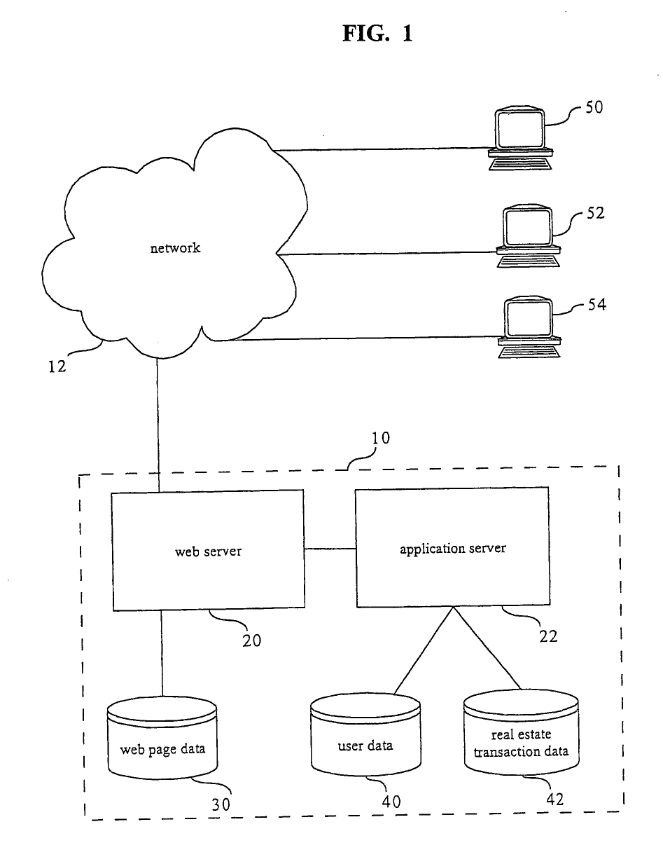

FIG. 1 is a block diagram depicting one embodiment of the present invention. Specifically, FIG. 1 shows a computer system 10 connected to a network 12. A computer system can include one computer or multiple computers (or other devices), and can include multiple computers in different locations operating as a system. Network 12 can be a local area network, a wide area network, a virtual private network, the Internet, an Intranet, or some other network suitable for use with the present invention.

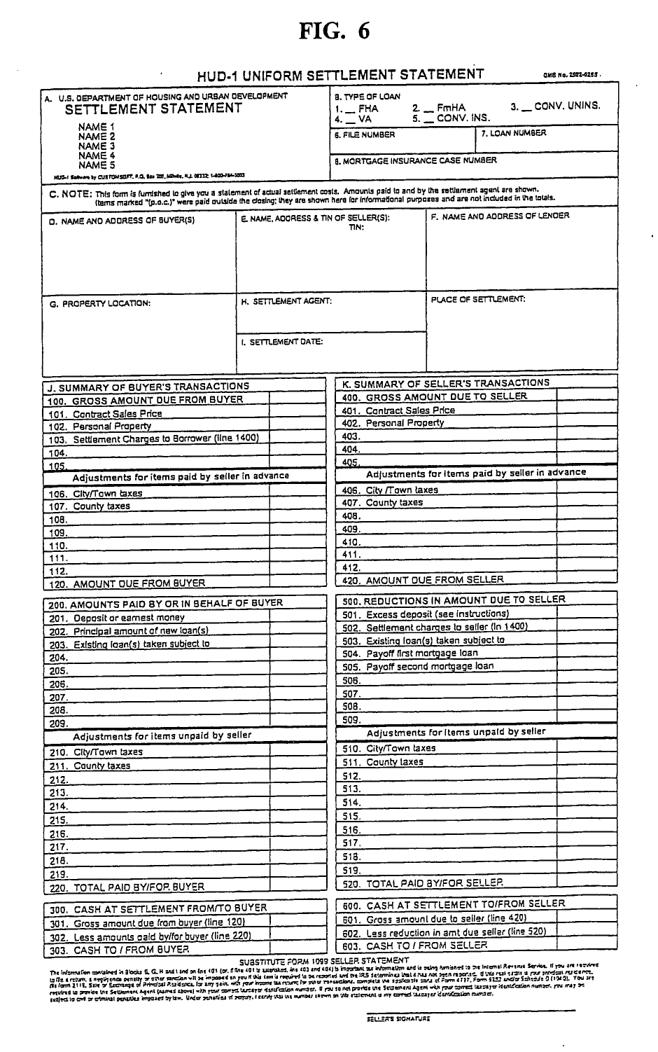

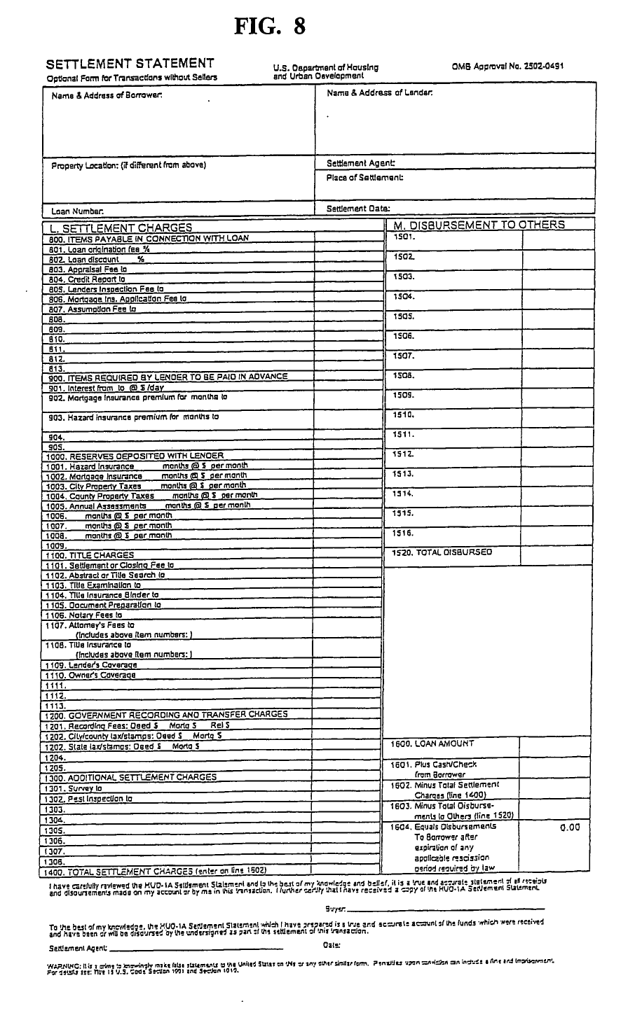

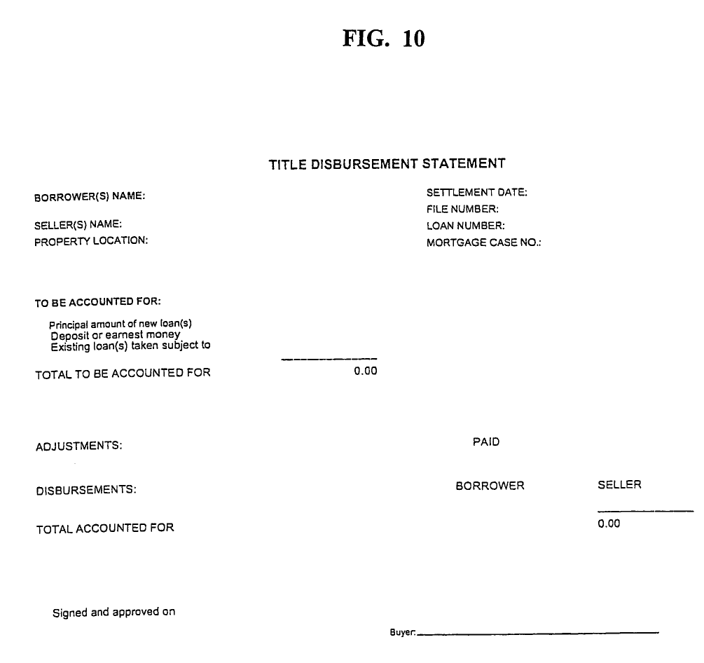

In one embodiment, computer system 10 is used to provide a method for producing real estate documents. Users are provided the ability to enter real estate transaction information into computer system 10. Wherein, users are able to store and modify the real estate transaction data 42 and produce the documents required by the Real Estate Settlement Procedures Act (RESPA) and specified in FIGS. 6-10. These documents are then transmitted to the user via network 12. Users are afforded the opportunity to purchase said documents. In another variation the user must pay to access the input screens generated by web server 20. In yet another incarnation, the user may pay for each use of the invention. Other variations and embodiments of the above description are within the spirit of the present invention.

Computer system 10 includes a web server 20 and an application server 22. In one embodiment, web server 20 and application server 22 include one or more processors, memory, a disk drive, input devices, output devices, network interfaces (e.g., modem, router, Ethernet card, etc.), and other peripherals, etc. In one embodiment of the present invention, network 12 is the Internet and computer system 10 provides a web site that is accessible over the Internet. In that embodiment, web server 20 provides an interface with users of computer system 10 by preparing and displaying web pages. In communication with web server 20 is web page data 30 which is used by web server 20 to prepare and provide web pages. In one embodiment, web page data 30 can be stored as part of web server 20. In other embodiments, web page data 30 can be stored in a separate storage medium.

Application server 22 performs the core functionality of the present invention, and is in communication with web server 20. In one embodiment, application server 22 instructs web server 20 to display certain web pages, and web server 20 communicates user input to application server 22. FIG. 1 shows application server 22 in communication with user data 40 and real estate transaction data 42. Each of the databases 40-42 can be separate databases stored in separate storage devices, can be combined into one or more than one storage device, can be stored separately from application server 22 (but in communication with application server 22) or can be stored within application server 22. Real estate transaction data 42 stores information about specific real estate transactions. User data 40 stores information about various users utilizing computer system 10.

FIG. 1 also shows three computers 50, 52 and 54 connected to network 12. In one embodiment, computers 50, 52 and 54 use browsers to access computer system 10 via the Internet. Computers 50, 52 and 54 are used by users to access the on-line real estate document services. Although three computers are depicted, more or less than three will work with the present invention. In another embodiment, users can access the services of computer system 10 using a telephone, handheld or palm computers, a wireless device or any other suitable means.

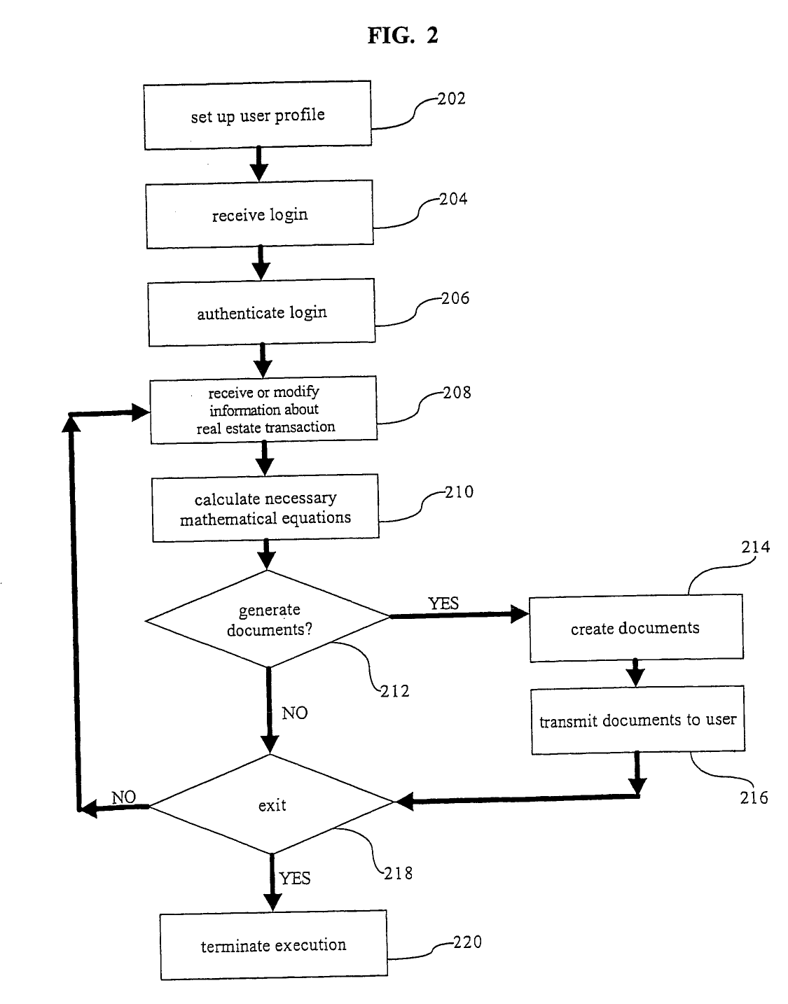

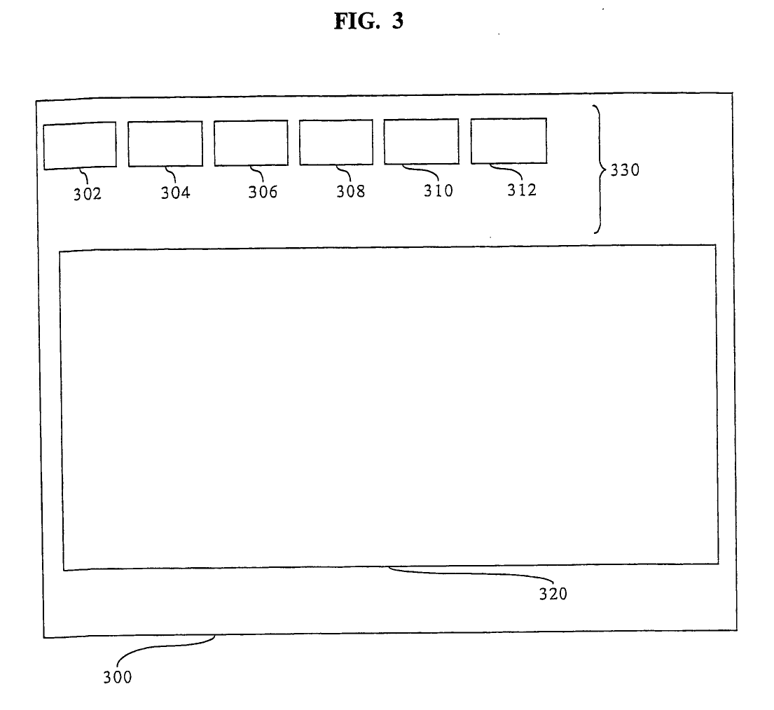

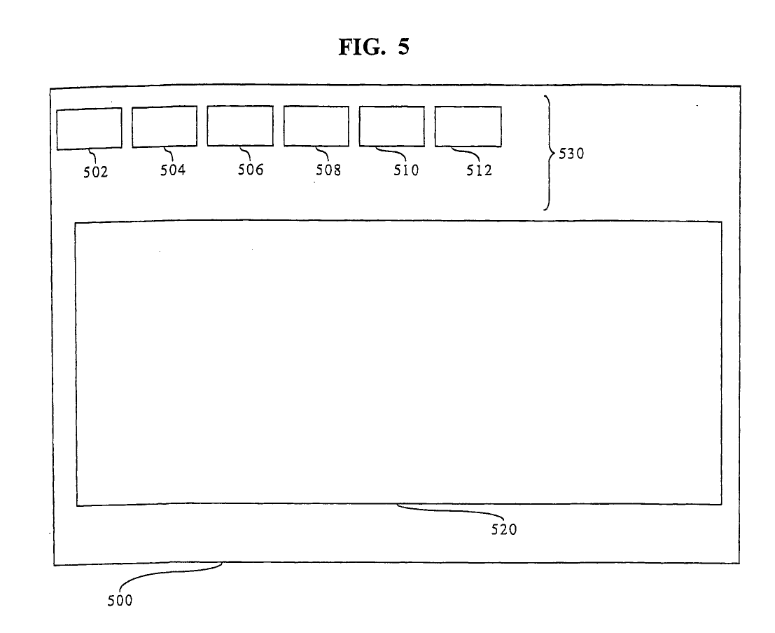

FIG. 2 is a flow chart depicting the flow of the method of the present invention. In step 202, the user sets up a user profile to be stored in user data 40. The user does this using web pages on web server 20. The user profiles include information about the user such as name, address, log in name, password, etc. If a user profile already exists, then step 202 may be skipped. In step 204, the user logs in. In step 206, computer system 10 authenticates the log in by checking the password and user name. After user authentication, application server 22 causes web server 20 to generate and display the Main Menu FIG. 3. The Main Menu Screen 300, in one embodiment, is equipped with a menu bar 330 and a drafting area 320. Drafting areas 320, 420, 520 allow information to be viewed, entered, modified or selected. The menu bar 330, in one embodiment, includes the following options: New 302; Open 304; Defaults 306; Amortization 308; Profile 310; and Exit 312. By selecting in a conventional manner New 302, Input Screen 400 will appear allowing the user to create a new real estate transaction to be entered and stored in the real estate transaction database 42. Selecting Open 304 in a conventional manner will display a listing of all real estate transaction files assigned to the authenticated user and stored in real estate transaction database 42. This listing will be shown in drafting area 320. By selecting in a conventional manner a particular file from the listing in drafting area 320, the user will open the selected file and Input Screen 400 will appear. By selecting in a conventional manner Defaults 306, a screen displaying user options and preferences will appear in drafting area 320 wherein these preferences may be entered or revised. These options and preferences are individually assigned to each user. Thus, each user may customize the default preferences to meet their particular requirements. These defaults are explained further in following paragraphs and in FIG. 5. By selecting Amortization 308, in a conventional manner, drafting area 320 will present the user with input fields that will calculate and produce a loan amortization schedule including loan amount, interest rate and number of payments. By selecting in a conventional manner Profile 310, information dealing with the user profile (e.g., name, address, email address, etc.) will appear in drafting area 320 wherein users may enter or revise this information. By selecting Exit 312, in a conventional manner, the program will terminate its execution.

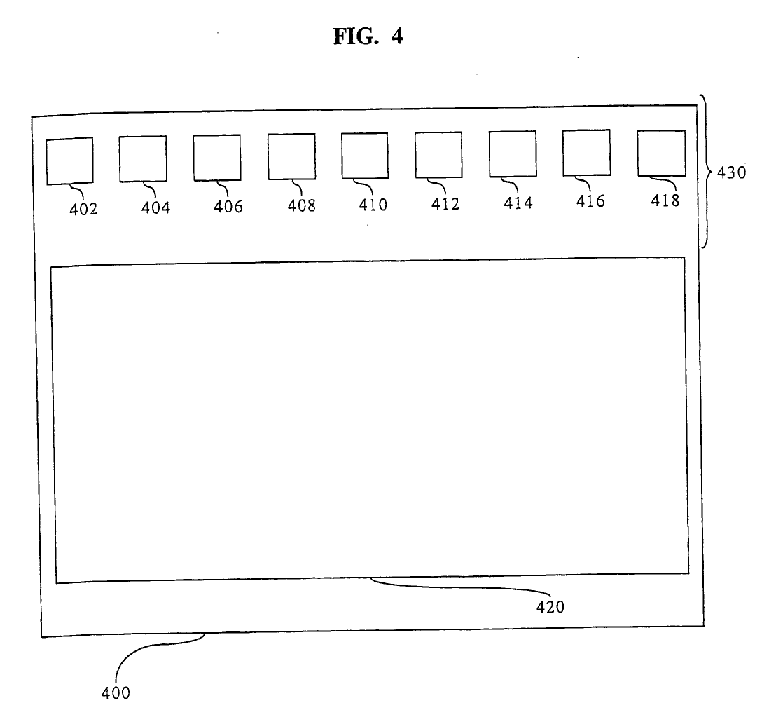

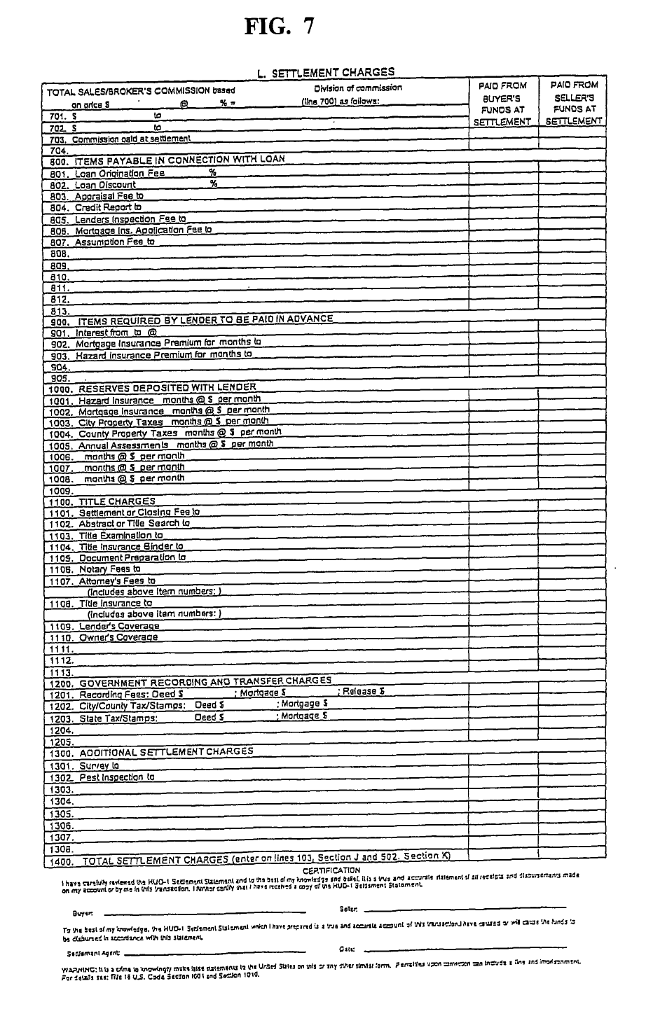

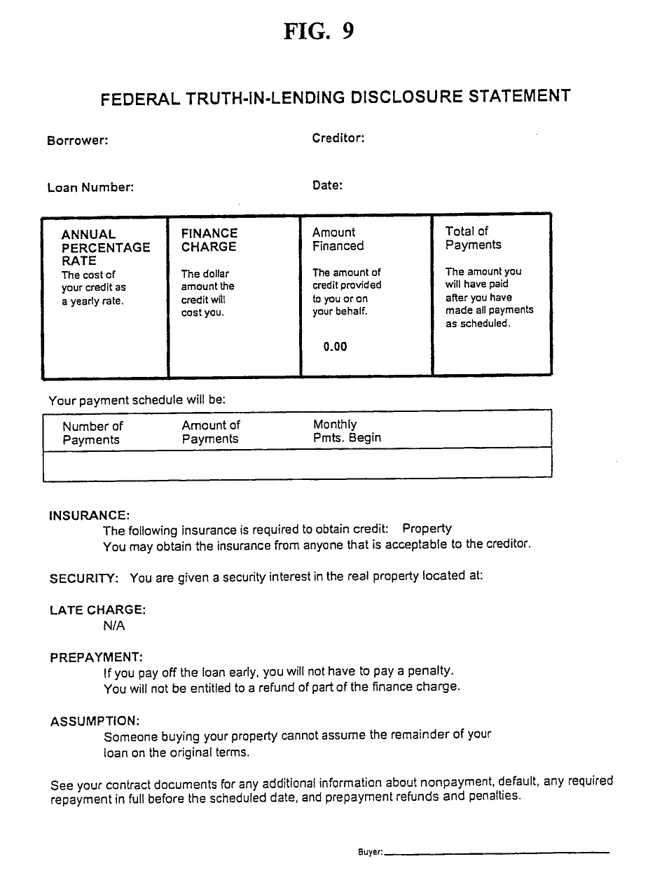

A typical display for entering information regarding the real estate transaction is illustrated in FIG. 4. The display where the user is to input data will be referred to as Input Screen 400, and will appear in many sections of the document generation application. To aid the user in drafting the real estate documents, in one embodiment, Input Screen 400 is equipped with a menu bar 430 and a drafting area 420. The menu bar 430, in one embodiment, includes the following options: Page 1 402; Page 2 404; Tax Adjustments 406; Prorate 408; Federal Truth-In-Lending 410; Save 412; Print 414; Register 416; and Exit 418. By selecting in a conventional manner Page 1 402, the information located on page one of the Housing and Urban Development Settlement Statement (HUD-1) form FIG. 6 will be displayed in drafting area 420. By selecting in a conventional manner Page 2 404, the information located on page two of the HUD-1 form FIG. 7 will be displayed in drafting area 420. By selecting in a conventional manner Tax Adjustments 406, the drafting area 420 will display a screen requesting the information needed to calculate the tax adjustments in the real estate transaction including the amount of taxes paid and the amount of taxes due. By selecting in a conventional manner Prorate 408, a window will appear requesting the information needed to prorate any amounts in the real estate transaction (e.g., water, sewer or condominium charges). This includes the proration dates, proration period, the amount due and the amount paid. By selecting in a conventional manner Federal Truth-In-Lending 410, drafting area 420 will display information required to complete the Federal Truth-In-Lending form FIG. 9 for the real estate transaction. This includes the mortgage amount, number of payments, interest rate, first payment date, points paid, origination fee, loan discounts and prepaid or other fees. By selecting in a conventional manner Save 412, the information data that has been entered by the user for the current real estate transaction will be saved in the real estate transaction data file 42. By selecting in a conventional manner Print 414, the real estate documents will be generated and delivered to the user via network 12. In one embodiment, unregistered documents will be transmitted to the user with an unremovable watermark (e.g., “For Sample Purposes Only” or “Do Not Reproduce”). In another embodiment, only partial documents will be transmitted to the user (e.g., only page one of the HUD-1 form). In yet another embodiment, the documents will not be transmitted until payment has been received. Other variations and embodiments of the above document transmission description are within the spirit of the present invention. By selecting in a conventional manner Register 416, the user is allowed to register the real estate documents. In the illustrated embodiment of the invention, registering is synonymous with purchasing. In registering the real estate document, the real estate document will be transmitted to the user in its entirety with no restrictions (e.g., without watermarks, containing all pages, etc.). In another variation, the user may register to create the documents. In another variation, the user may register for transmission of the documents. In yet another variation, the user may register to access the real estate document services on computer system 10. Other variations and embodiments of the above registration descriptions are within the spirit of the present invention. By selecting in a conventional manner Exit 418, the user will return to the Main Menu Screen 300.

FIG. 5 is a representation of a computer screen in the illustrated embodiment of the invention representing an interface with the user to provide default settings. These default settings are options that allow the user to customize the workings of the invention to their specific needs. The display where the user is to input data will be referred to as Default Screen 500, and will appear in many sections of the user defaults. To aid the user in setting the defaults, in one embodiment, the Default Screen 500 is equipped with a menu bar 530 and a drafting area 520. Drafting area 520 will contain the various input and selection screen displays. The menu bar 530, in one embodiment, includes Taxes 502; User Options 504; Page 1 506; Page 2 508; Truth-In-Lending 510 and Exit 512. By selecting in a conventional manner Taxes 502, the user is able to choose the state tax, tax due date, whether taxes are paid once a year, and which line to place the taxes on (e.g., line 1201, 1202 or 1203 of the HUD-1 form FIG. 7). By selecting in a conventional manner User Options 504, the user can select whether to count the current day in the proration calculations, autocalculate lines 701 and 702 FIG. 7, automatically carry figures from line 201 to line 501 FIG. 6, use the words “buyer” and “seller” or “borrower” and “lender” when creating the documents, automatically enter the address of the seller into the property location FIG. 6, print shaded or unshaded boxes on lines 1001-1009 FIG. 7, and print shaded or unshaded boxes on lines 1107, 1108-1110 FIG. 7. By selecting Page 1 506 in a conventional manner, the user is presented a screen depicting a blank page one of the HUD-1 form FIG. 6 in which to enter information that will automatically appear on page one of the HUD-1 form each time a new document is created. By selecting Page 2 508 in a conventional manner, the user is presented a screen depicting a blank page two of the HUD-1 form FIG. 7 in which to enter information that will automatically appear on page two of the HUD-1 form each time a new document is created. By selecting Truth-In-Lending 510 in a conventional manner, the user is presented a screen depicting the Federal Truth-In-Lending document FIG. 9 in which to enter information that will automatically appear on the Federal Truth-In-Lending document each time a new document is created. By selecting in a conventional manner Exit 512, the user will return to Main Menu Screen 300.

Returning now to the operation of the invention and flow of the method for calculating and producing RESPA documents FIG. 2, computer system 10 receives information about the real estate transaction from the user via screen displays generated by application server 22 in connection with web server 20. When presented with Input Screen 400, the user may input or modify the real estate transaction information 208. The user inputs some or all information presented in FIGS. 6-9. By entering the real estate information, the invention will calculate 210 any mathematical equations necessary to complete the RESPA documents. The user may then choose to generate RESPA documents 212. By choosing to generate RESPA documents, the documents will be created 214 and transmitted 216 via network 12 to the user. In the preferred embodiment of the invention, these documents are created and transmitted in portable document format (PDF) in such that any user with a PDF reader (e.g., Adobe Acrobat Reader) can access and print the forms. In another adaptation, these forms may be created and transmitted as word processing documents (e.g., Word, Word Perfect, etc.). In yet another adaptation, these forms may be created and transmitted as images (e.g., TIFF, JPEG, etc). The user is also allowed to exit the invention 218 in which case the invention will terminate 220. Alternatively, the user may choose not to exit but to continue working with the invention to input or revise real estate transaction information 208. The steps in FIG. 2 are primarily performed by web server 20 using web page data 30 along with information supplied by application server 22. Specific source code for most of the functions and calculations shown in FIG. 2 is given in the appendix. Specific source code for generating most of the screen display functions shown in FIGS. 3-5 is given in the appendix. FIGS. 6-10 are representations of documents produced using the invention. Specific source code for generating the documents shown in FIGS. 6-10 is given in the appendix.

In one embodiment of the invention, the primary programming language used is Pascal and the entire real estate document services program is compiled into a single Dynamic Link Library (DLL) which may be loaded as an active server page on a web server. Hyper Text Markup Language (HTML) and Javascript code is generated by the document services DLL program located on application server 22 and passed to web server 20. Specific source code for generating most of the DLL, HTML and Javascript code is given in the appendix.

Thus, the reader will see that the invention provides an easy and reliable method to calculate and produce real estate (RESPA) documents. The preferred embodiment of the invention allows users to generate the completed documents without the complications and expense of obtaining, purchasing and installing an entire real estate software package. Since the software used by the invention is located on computer system 10, the invention always affords users access to the latest working version of the software. No computer software updates or multiple user licenses need be purchased. Plus, the preferred embodiment of the invention provides the ability to access, modify and produce real estate (RESPA) documents from any location via the Internet.

While the invention has been described in connection with a preferred embodiment, it is not intended to limit the scope of the invention to the particular form set forth, but on the contrary, it is intended to cover such alternatives, modifications, and equivalents as may be included within the spirit and scope of the invention as defined by the appended claims.

1. a process for producing real estate documents comprising:
a central controller including a central processing unit (CPU) and a memory operatively connected to the CPU;
a storage means for storing data on a storage medium connected to the central controller;
at least one terminal, adapted for communicating with the central controller, for transmitting to the central controller information about the real estate transaction;
the memory in the central controller containing a program, adapted to be executed by said CPU, for calculating the mathematical results of the information entered;
said program is also adapted for generating real estate documents;
said program is further adapted to transmit real estate documents to said terminal;
wherein said central controller receives real estate transaction information from said terminal and calculates the results based upon the information entered; and
wherein said central controller receives real estate transaction information from said terminal, produces the requested documents and transmits the documents to said terminal; and
wherein the program in memory is further adapted to perform a credit card or other payment transaction to provide the real estate document services to the customer.
